(19) United States
(12) Patent Application Publication
(10) Pub. No.: US 2025/0008009 A1
(43) Pub. Date: Jan. 2, 2025

(54) SMARTPHONE OPTICAL DEVICE ADAPTER

(71) Applicant: Zachary Daniel Adams, Boise, ID (US)

(72) Inventor: Zachary Daniel Adams, Boise, ID (US)

(21) Appl. No.: 18/217,500

(22) Filed: Jun. 30, 2023

(51) Int. Cl. H04M 1/02; G03B 17/14; G03B 17/56; H04M 1/72409

(52) U.S. Cl. CPC H04M 1/0264; G03B 17/14; G03B 17/565; H04M 1/72409

(57) ABSTRACT

A smartphone optical device adapter consisting of an alignment tool, mounting plate, adapter ring, and spacer that attaches to the back of a smartphone is aligned with the camera(s) on the back of the smart phone. An optical device is attached to the smartphone optical device adapter allowing the user to take videos or pictures quickly and efficiently through the optical device using the smartphone.

### BACKGROUND

### Field of the Invention

The current invention is a novel method of mounting, spacing, and centering a smartphone camera utilizing a novel smartphone optical device adapter onto any suitable optical device such as, but not limited to, a telescope, spotting scope, or monocular.

The ability to use a smartphone camera in conjunction with an optical device has been growing in popularity since smartphone cameras have gotten better. There are a few different methods of attaching and centering a smartphone camera on an optical device. Most of the current systems use some sort of bulky mount that requires the user to turn dials or move sliders to center the phone camera onto the optical device. The other options that are currently available don't require the user to adjust the position in the mount, however it requires the user to own a specific case and adapter system.

While using and testing several of the systems available, a few key disadvantages were noticed. One is ease of use, most of the systems that require the user to finely tune the position of the phone in the mount, is time consuming and creates an annoyance when that process must be repeated. Another issue is requiring the user to either use a very specific case or no case on their phone at all. This is not ideal as the cases may be useful when used in the mounting system, but overall, the cases in the system are bulky and do not offer much protection. Additionally, requiring specific cases forces the user to purchase a new case if the user obtains a new device for some reason. The last major issue with the current systems is physical size. Whether it's an adjustable system or a system with a case, either way they are too large to fit comfortably in someone's pocket.

What is needed in the art is a new adapter that allows the user to mount their smartphone to an optical device while being able to use their own phone case, fit the system in a pocket while still centering the phone camera on the optical device and being able to quickly attach and detach the phone.

### SUMMARY

This Summary is provided to introduce in a simplified form a selection of concepts that are further described below in the Detailed Description. This Summary is not intended to identify key or essential features of the claimed subject matter, nor is it intended to be used to limit the scope of the claimed subject matter.

The Detailed Description below describes a smartphone optical device adapter. The solution described below enables a user to use the smartphone optical device adapter.

As used herein, “at least one,” “one or more,” and “and/or” are open-ended expressions that are both conjunctive and disjunctive in operation. For example, each of the expressions “at least one of A, B and C,” “at least one of A, B, or C,” “one or more of A, B, and C,” “one or more of A, B, or C,” and “A, B, and/or C” means A alone, B alone, C alone, A and B together, A and C together, B and C together, or A, B, and C together. When each one of A, B, and C in the above expressions refers to an element, such as X, Y, and Z, or class of elements, such as X1-Xm, Y1-Yn, and Z1-Zo, the phrase is intended to refer to a single element selected from X, Y, and Z, a combination of elements selected from the same class (e.g., X1 and X2) as well as a combination of elements selected from two or more classes (e.g., Y1 and Z3).

It is to be noted that the term “a entity” or “an entity” refers to one or more of that entity. As such, the terms “a” (or “an”), “one or more,” and “at least one” can be used interchangeably herein. It is also to be noted that the terms “comprising,” “including,” and “having” can be used interchangeably.

The novel smartphone optical device adapter of the present invention comprises four parts: alignment tool, mounting plate, adapter ring, and spacer. The first part is an alignment tool to position the mounting plate in the device-specific position according to the camera lens of the phone. The second part is the mounting plate which is attached to or is secured upon a smartphone or phone case. The mounting plate is designed to lock into the adapter ring tightly enough to hold the weight on the smartphone in any configuration. The third part is an adapter ring used to attach or secure the mounting plate to the optical device while centering the camera system to the camera lens of the optical device. The fourth part is an interchangeable spacer which attaches to the adapter ring. The interchangeable spacer is available in varying sizes to accommodate the multiple optical device manufacturer's eyepiece dimensions. In an embodiment, the user will lock the spacer into the adapter ring and slide the spacer and adapter ring on to the eyepiece of the optical device. The user will then be able to quickly slide in and lock the mounting plate, attaching and centering the smartphone to the optical device.

### BRIEF DESCRIPTION OF THE SEVERAL VIEWS OF THE DRAWINGS

FIG. 1 shows an isometric view of the alignment tool and the mounting plate in an embodiment of the smartphone optical device adapter.

FIG. 2 shows an isometric view of the adapter ring in an embodiment of the smartphone optical device adapter.

FIG. 3A shows an isometric view of the spacer and FIG. 3B shows a plan view of the spacer in an embodiment of the smartphone optical device adapter.

FIG. 4 shows an isometric exploded view showing how the four parts fit together in an embodiment of the smartphone optical device adapter.

FIG. 5 shows an isometric front view of the four parts attached to a smartphone in an embodiment of the smartphone optical device adapter.

FIG. 6A shows a back plan view of the four parts attached to a smartphone in an embodiment of the smartphone optical device adapter and FIG. 6B shows a vertical section view of FIG. 6A.

FIG. 7 shows a flow chart of a method in an embodiment of using the smartphone optical device adapter.

To assist in the understanding of the present disclosure the following list of components and associated numbering found in the drawings is provided herein:

TABLE of
Components

| Component | # |
|---|---|
| alignment tool | 1 |
| hole | 1A |
| hole | 1B |
| mounting plate | 2 |
| upper plate | 2A |
| base plate | 2B |
| mating fixture | 2C |
| adapter ring | 3 |
| adapter slot | 3A |
| adapter slot | 3B |
| locking pin | 3C |
| spacer | 4 |
| grippers | 4A |
| L-shaped locking slot | 4B |
| circular grip | 4C |
| stopper lip | 4D |
| optical device | 5 |
| smartphone | 6 |
| camera lens | 7 |
| smartphone optical device adapter | 10 |

### DETAILED DESCRIPTION

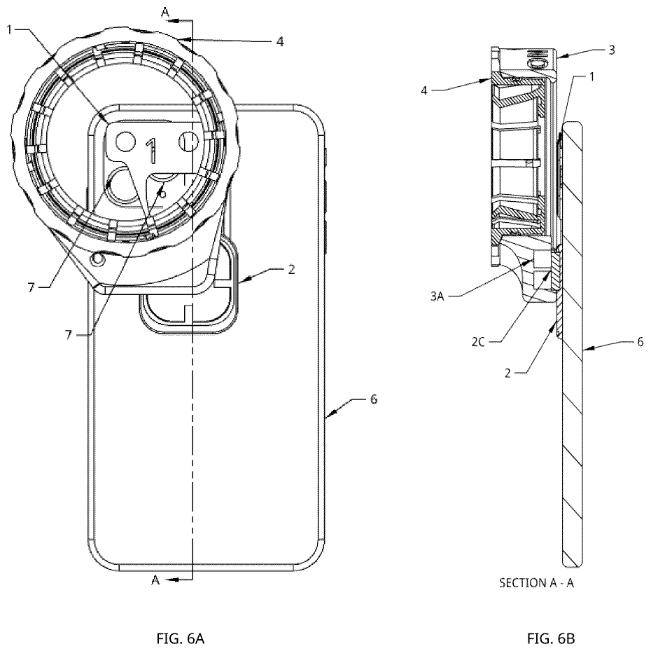

Referring now to the Figures, like reference numerals and names refer to structurally and/or functionally similar elements thereof, and if objects depicted in the figures that are covered by another object, as well as the tag line for the element number thereto, may be shown in dashed lines. FIG. 1A shows an isometric view of the alignment tool and the mounting plate in an embodiment of the smartphone optical device adapter and FIG. 1B shows an isometric view of the mounting plate with alignment tool removed in an embodiment of the smartphone optical device adapter. Referring now to FIGS. 1A and 1B, the alignment tool 1 consists of two separate holes 1A and 1B. These holes 1A and 1B correspond to the possible positions of camera lenses 7 on most smartphones. Hole 1A corresponds to smartphones with cameras in the upper left when looking at the back side of the smartphone. Hole 1B corresponds to smartphones that have cameras centered on the back of the smartphone. Another embodiment includes a third hole that corresponds to the upper right location for the camera (not shown in FIG. 1). The alignment tool 1 is rigidly fixed to mounting plate 2. Once the mounting plate 2 is secured to the smartphone and the associated holes 1A or 1B is appropriately aligned to the corresponding camera, alignment tool 1 can be removed by breaking it off as shown in FIG. 1B. In typical use alignment tool 1 will be broken off but it does not necessarily have to be as is shown in FIG. 6A. Mounting plate 2 comprises an upper plate 2A, a base plate 2B, and a mating fixture 2C. The bottom side of base plate 2B is the flat surface that will attach to the smartphone 6 via a suitable adhesive tape, such as two-way sticky tape, two-way sticky tape with a backing on one side that has to be peeled off to expose the second sticky side, or two-way sticky tape with a backing on both sides that has to be peeled off to expose both sticky sides. The mating fixture 2C is the piece that is responsible for connecting the mounting plate 2 to the adapter ring 3. The mating fixture 2C is rigidly attached to the upper plate 2A. In the embodiment shown in FIGS. 1A and 1B the mating fixture 2C is a magnet that is recessed into the upper plate 2B. However, other methods of securing the mounting plate 2 to the adapter ring 3 in lieu of mating fixture 2C may be used, such as a slide lock, a twist lock, or a friction fit, to secure the mounting plate 2 to the adapter ring 3. The function of the mounting plate 2 is the same regardless of how it is attached to the adapter ring 3. The mating function, however, could be accomplished in the other embodiments suggested and is not specific to the shape, dimensions, or orientation of the mounting plate 2 shown in FIG. 1A. Additionally, the mating fixture 2C on upper plate 2A and the base plate 2B is designed to keep the optical device 5 from rotating inside the adapter slots 3A or 3B, using square edges of mating fixture 2C and an interference fit within adapter slots 3A and 3B. Some embodiments could require other shapes or designs to achieve the same result of keeping the optical device 5 from rotating inside the adapter slots 3A or 3B.

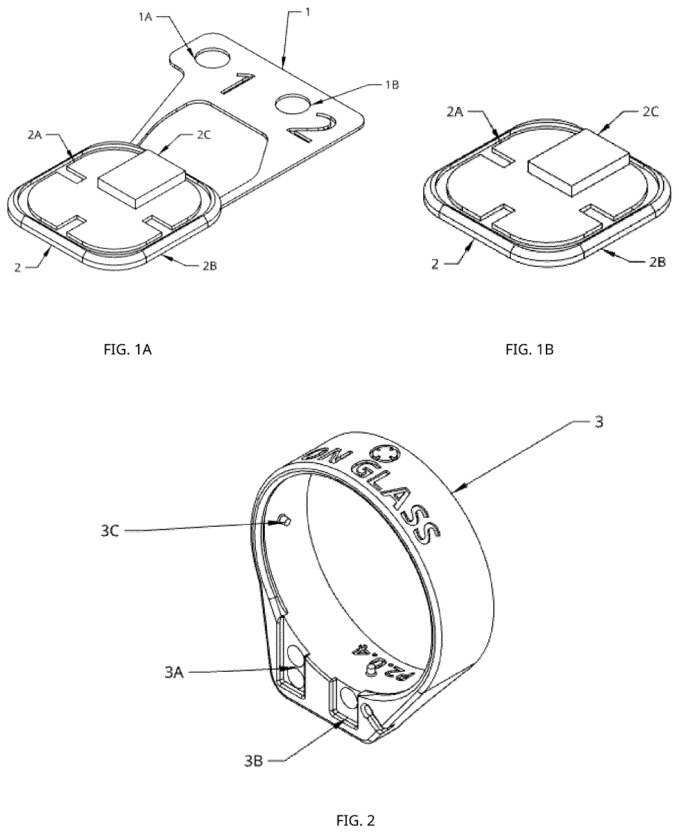

FIG. 2 shows an isometric view of the adapter ring in an embodiment of the smartphone optical device adapter. Referring now to FIG. 2, adapter ring 3 has two adapter slots 3A and 3B. The adapter slots 3A and 3B correlate to the holes 1A and 1B on the alignment tool 1. This means that if hole 1A is used when attaching mounting plate 2 to smartphone 5, then adapter slot 3A would be used when attaching mating fixture 2C to the adapter ring 3. If hole 1B was used when attaching mounting plate 2 to smartphone 5, then adapter slot 3B would be used. For example, if the smartphone 5 has a camera lens 7 in the upper left corner, the appropriate hole on the alignment tool 1 would be hole 1A. Once base plate 2B is attached to the smartphone 6, because hole 1A on the alignment tool 1 is used, when attaching the mounting plate 2 to the adapter ring 3, mating fixture 2C must be placed into adapter slot 3A. This ensures that the adapter ring 3 is centered on the camera lens 7 of the smartphone 5. Once base plate 2B is attached to the phone the upper plate 2A will attach to the adapter ring 3 in the correct adapter slot 3A or 3B as described above. This ensures that the camera lens 7 of the phone will be centered in the adapter ring 3. In the embodiment shown in FIGS. 1A and 1B, the upper plate 2A attaches to the adapter ring 3 magnetically via mating fixture 2C. In other embodiments the adapter slots 3A and 3B may have different sizes and orientations. For example, the adapter slots 3A and 3B may be oriented horizontally to allow the mounting plate 2 and the attached smartphone 5 to slide horizontally relative to the adapter ring 3. Adapter slots 3A and 3B may also be sized differently to accommodate other mounting plate options.

Also, in FIG. 2 on the inner diameter surface of adapter ring 3, there is the locking pin 3C. This locking pin 3C is designed so that spacer 4 can be inserted and locked into place to keep it from pulling out of position. In one embodiment the locking pin 3C will fit snugly into the L-shaped locking slot 4B on the outer surface of spacer 4 and rotated to lock into position. Other embodiments may include differing locking styles, such as press fit, screw in, friction fit, etc.

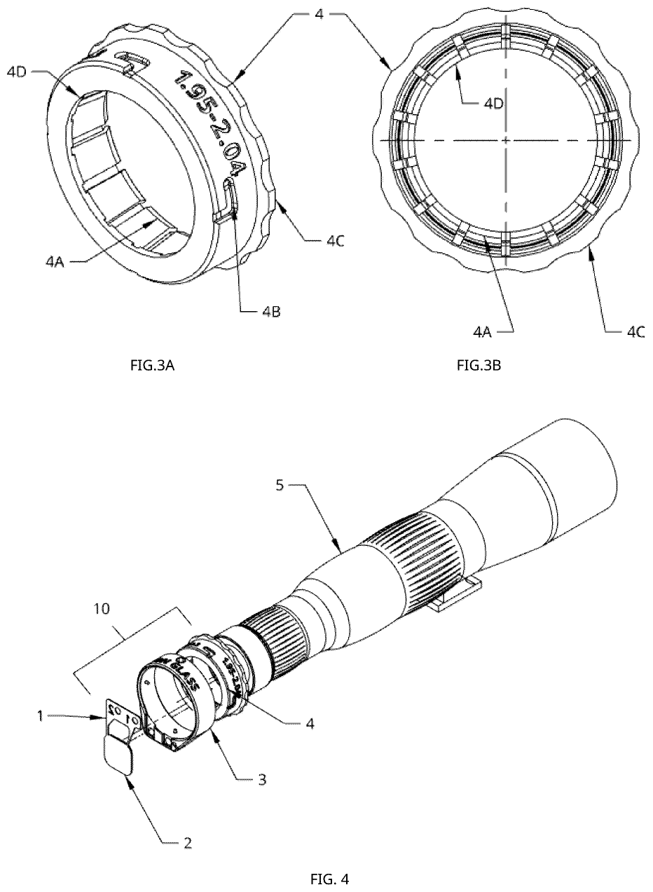

FIG. 3A shows an isometric view of the spacer and FIG. 3B shows a plan view of the spacer in an embodiment of the smartphone optical device adapter. Referring now to FIGS. 3A and 3B, spacer 4 consists of a plurality of grippers 4A located around the inside diameter of the spacer 4. The grippers 4A are what attach the spacer 4 to the optical device 5. The grippers 4A allow the spacer 4 to have a friction force that is greater than or equal to the weight of the mobile device, on varying sizes of eyepieces. This means that one spacer 4 may fit multiple different eyepiece diameters. In one embodiment, to ensure the proper fit of the spacer 4 onto the eyepiece of the optical device 5, the spacer 4 has enough inherent elasticity to expand 3-7% over the starting diameter. In other embodiments, the spacer 4 could have different methods of attaching to the eyepiece of the optical device 5. Some embodiments of the spacer 4 will have varying surface textures and finishes to accommodate differing amounts of grip. The spacer 4 also includes the L-shaped locking slot 4B which corresponds to the previously mentioned locking pin 3C. Additionally, the spacer 4 has a circular grip 4C located around the perimeter of spacer 4 with the purpose of giving the user a surface to easily manipulate the spacer 4 into the adapter ring 3. Lastly, the spacer 4 has a stopper lip 4D extending inwardly around an inner circumference of spacer 4. The purpose of the stopper lip 4D is to keep the spacer 4 from sliding too far onto the optical device 5 as well as making sure the spacer 4 is square on the optical device 5. Different embodiments of the spacer 4 will include many different sizes and orientations. The outside diameter of the spacer 4 is sized to smoothly slide into the adapter ring 3 but does not have excess space between the outside diameter of the spacer 4 and the inside diameter of the adapter ring 3.

FIG. 4 shows an isometric exploded view showing how the four parts fit together in an embodiment of the smartphone optical device adapter. Referring now to FIG. 4, the exploded view more accurately shows the attachment points and mounting surfaces of the different parts of the smartphone optical device adapter 10. The alignment tool 1, mounting plate 2 using the mating fixture 2C, slides into one either the first adapter slot 3A or the second adapter slot 3B. The base plate 2B will attach to the smartphone via adhesive in one embodiment or other ways in other embodiments. The spacer 4 slides into the adapter ring 3 where the locking pin 3C fits into and twists locks in the L-shaped locking slot 4B. The spacer 4 fits snugly onto the eyepiece of the optical device 5. Once all parts of smartphone optical device adapter 10 are properly assembled, the smartphone 6 camera will be appropriately spaced away from and centered on the eyepiece of the optical device creating a clear and unobstructed view through the optical device 5.

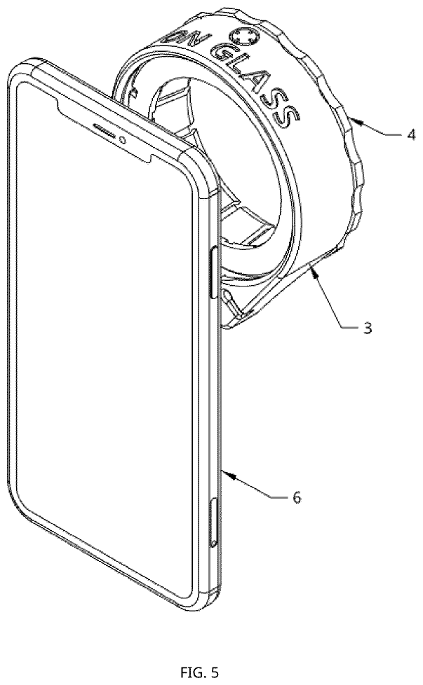

FIG. 5 shows an isometric front view of the four parts attached to a smartphone in an embodiment of the smartphone optical device adapter. Referring now to FIG. 5, with this view the smartphone 6 engages with the adapter ring 3 and the spacer 4. In this embodiment the assembled components are aligned with a top corner camera lens 7.

FIG. 6A shows a back plan view of the four parts attached to a smartphone in an embodiment of the smartphone optical device adapter and FIG. 6B shows a vertical section view of FIG. 6A. Referring now to FIGS. 6A and 6B, FIG. 6A shows how the alignment tool 1, mounting plate 2, adapter ring 3, and spacer 4 engage with the smartphone 6. This is how the smartphone optical device adapter 10 looks when all parts are completely assembled. FIG. 6B shows how mating fixture 2C engages with hole 3A. The mating fixture 2C is sized so that it fits inside of adapter slot 3A and prevents adapter ring 3 from rotating. It is not a requirement to break off alignment tool 1 from mounting plate 2 as optical device 5 will work fine with the alignment tool 1 still attached to mounting plate 2 as shown in FIG. 6A. However, in common use most users will most likely choose to break it off.

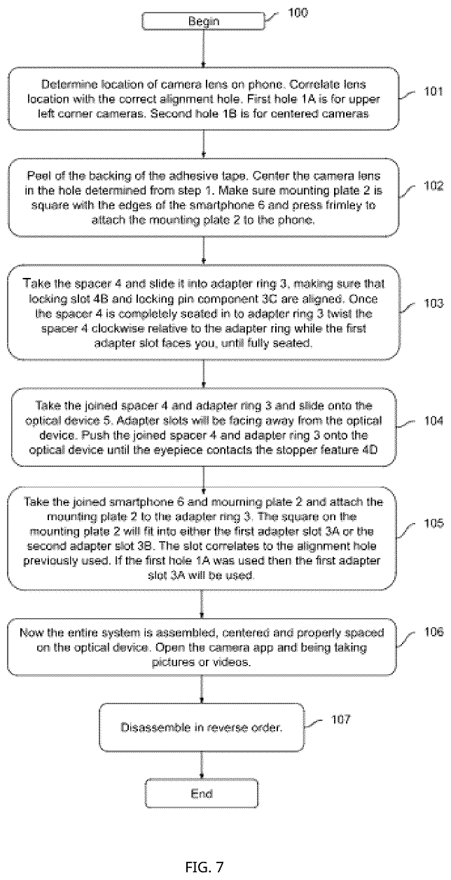

FIG. 7 shows a flow chart of a method in an embodiment of using the smartphone optical device adapter. Referring now to FIG. 7, this flow chart describes how to assemble and use the entire smartphone optical device adapter 10. This is a step-by-step explanation of how to go from no parts assembled to the smartphone 6 being mounted, aligned, and centered on the optical device 5.

In step 101 the location of the camera lens 7 on the smartphone 6 is determined. The camera lens 7 location is correlated with the correct hole 1A or 1B. Hole 1A is for a camera lens 7 located in an upper left corner of a smartphone 6. Hole 1B is for a camera lens 7 in an upper center of a smartphone 6.

In step 102 a first side of an adhesive tape is attached to the back side of mounting plate 2 and any backing, if any, is peeled off of the second side of the adhesive tape. Using the correct hole 1A or 1B determined in step 101, the camera lens 7 of the smartphone 6 is centered on the correct hole 1A or 1B. Before sticking the mounting plate 2 to the smartphone 6, the mounting plate is positioned square with the edges of the smartphone 6. The mounting plate 2 with the adhesive tape exposed is then firmly pressed to the smartphone 6 to secure the two together.

In step 103 spacer 4 is pushed into adapter ring 3 by aligning locking pin 3C on the interior of the adapter ring 3 with the first leg of the L-shaped locking slot 4B on the exterior of the spacer 4. Once the spacer 4 is completely seated into the adapter ring 3, the spacer 4 is rotated relative to the adapter ring 3 until the locking pin 3C is fully engaged with the second leg of the L-shaped locking slot 4B and thus securely joining the two together.

In step 104 the adapter ring 3 and spacer 4 now joined together are slid onto the eyepiece of the optical device 5 with the adapter slots 3A and 3B of adapter ring 3 facing away from the optical device 5. The optical device 5 and spacer 4 are slid together until the optical device 5 abuts with the stopper lip 4D at the end of the spacer 4.

In step 105 the mounting plate 2 and smartphone 6 now joined together are attached to the adapter ring 3. This is done by placing the mating feature 2C into the correct adapter slot 3A or 3B according to which hole 1A or 1B was used in step 101. This means if hole 1A was used in step 101 then slot 3A will be used in step 105. If hole 1B was used in step 101 then slot 3B will be used in step 105.

In step 106 now that step 105 is complete and the smartphone 6 is attached, centered, and properly aligned to the optical device 5, the camera app can be opened, and the user can begin taking pictures or videos.

In step 107 the smartphone optical device adapter 10 is disassembled in reverse order.

The smartphone optical device adapter 10 is not limited to any specific materials. While some references to materials are mentioned in the description above, some or all of the elements of the system in other embodiments may be comprised of wood, plastics, metal alloys, aluminum, rubber, foam, or other materials.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims. It will be understood by those skilled in the art that many changes in construction and widely differing embodiments and applications will suggest themselves without departing from the scope of the disclosed subject matter.

What is claimed is:

1. A method for mounting, spacing, and centering a smartphone camera onto an optical device, the method comprising the steps of:
(a) securing a mounting plate to a smartphone so that at least one hole of an alignment tool that is attached to the mounting plate is correlated to a camera lens of the smartphone;
(b) pushing a spacer into an adapter ring securely joining the spacer and the adapter ring together;
(c) sliding the spacer onto an eyepiece of an optical device; and
(d) attaching the adapter ring to the mounting plate attached to the smartphone.

2. The method for mounting, spacing, and centering a smartphone camera onto an optical device according to claim 1 further comprising the step of:
Using the smartphone with the optical device attached thereto to take at least one of a picture and a video.

3. The method for mounting, spacing, and centering a smartphone camera onto an optical device according to claim 1 wherein the at least one hole of the alignment tool s correlated to a camera lens located in an upper left corner of the smartphone.

4. The method for mounting, spacing, and centering a smartphone camera onto an optical device according to claim 1 wherein the at least one hole of the alignment tool is correlated to a camera lens located in an upper center of the smartphone.

5. The method for mounting, spacing, and centering a smartphone camera onto an optical device according to claim 1 wherein securing step (a) further comprises the steps of:
attaching a first side of an adhesive tape to the mounting plate; and
pressing firmly the mounting plate with a second side of the adhesive tape exposed to the smartphone.

6. The method for mounting, spacing, and centering a smartphone camera onto an optical device according to claim 1 wherein pushing step (b) further comprises the steps of:
aligning a locking pin on an interior of the adapter ring with a first leg of an L-shaped locking slot on an exterior of the spacer; and
rotating the spacer relative to the adapter ring until the locking pin is fully engaged with a second leg of the L-shaped locking slot.

7. The method for mounting, spacing, and centering a smartphone camera onto an optical device according to claim 1 wherein sliding step (c) further comprises the steps of:
abutting the optical device against a stopper lip at an end of the spacer.

8. The method for mounting, spacing, and centering a smartphone camera onto an optical device according to claim 1 wherein attaching step (d) further comprises the steps of:
engaging at least one of an adapter slot with a mating fixture of the mounting plate.

9. An apparatus for mounting, spacing, and centering a smartphone camera onto an optical device comprising:
an alignment tool having at least one hole;
a mounting plate attached to the alignment tool;
an adapter ring configured to attach to the mounting plate; and
a spacer configured to attach to the adapter ring;
wherein the mounting plate is configured to attach to a smartphone and an optical device is configured to attach to the spacer.

10. The apparatus for mounting, spacing, and centering a smartphone camera onto an optical device according to claim 9 wherein the mounting plate further comprises:
an upper plate;
a base plate; and
a mating fixture rigidly attached to the upper plate.

11. The apparatus for mounting, spacing, and centering a smartphone camera onto an optical device according to claim 10 wherein the mating fixture is a magnet recessed into the upper plate.

12. The apparatus for mounting, spacing, and centering a smartphone camera onto an optical device according to claim 9 wherein the adapter ring is configured to attach to the mounting plate by at least one of a side lock, a twist lock, and a friction fit.

13. The apparatus for mounting, spacing, and centering a smartphone camera onto an optical device according to claim 9 wherein the adapter ring further comprises:
at least one adapter slot; and
a locking pin.

14. The apparatus for mounting, spacing, and centering a smartphone camera onto an optical device according to claim 9 wherein the spacer further comprises:
a plurality of grippers located around an inside diameter of the spacer;
an L-shaped locking slot located on an outer surface of spacer;
a circular grip located around the perimeter of spacer; and
a stopper lip extending inwardly around an inner circumference of spacer.
